(19) United States
(12) Patent Application Publication
(10) Pub. No.: US 2014/0143866 A1
(43) Pub. Date: May 22, 2014

(54) METHOD OF INSPECTING MASS WEBSITES AT HIGH SPEED

(71) Applicant: Korea Internet & Security Agency, Seoul (KR)

(72) Inventors: Tai Jin LEE, Seoul (KR); Byung Ik KIM, Seoul (KR); Hong Koo KANG, Seoul (KR); Chang Yong LEE, Seoul (KR); Ji Sang KIM, Seoul (KR); Hyun Cheol JEONG, Seoul (KR)

(73) Assignee: Korea Internet & Security Agency, Seoul (KR)

(21) Appl. No.: 14/065,706

(22) Filed: Oct. 29, 2013

(30) Foreign Application Priority Data
Nov. 19, 2012 (KR) 10-2012-0130958

(51) Int. Cl. H04L 29/06

(52) U.S. Cl. CPC H04L 63/145
USPC 726/22

(57) ABSTRACT

Disclosed is a method of inspecting mass websites at a high speed, which visits and inspects the mass websites at a high speed and, at the same time, correctly detects unknown attacks, detection avoidance attacks and the like and extracts URLs related to vulnerability attacks. The method of inspecting mass websites at a high speed includes the steps of: simultaneously visiting, if a list of inspection target websites is received, a plurality of inspection target websites using multiple browsers; inspecting whether or not malicious code infection is attempted at the plurality of inspection target websites visited through the multiple browsers; extracting a malicious website where the attempt of malicious code infection is generated among the plurality of inspection target websites; and visiting the malicious website and tracing a malicious URL distributing a malicious code.

### BACKGROUND OF THE INVENTION

1. Field of the Invention

The present invention relates to a method of inspecting mass websites at a high speed, which visits and inspects the mass websites at a high speed and, at the same time, correctly detects unknown attacks, detection avoidance attacks and the like and extracts URLs related to vulnerability attacks.

2. Background of the Related Art

Although a web gives us great convenience and almost all the people in the world use the web every day, it is frequently but maliciously used as a medium for spreading a malicious code without the knowledge of a user. When a website frequently visited by users is maliciously used for distributing a malicious code, it needs to pay special attention since damage of the users can be expanded greatly. Expansion of the damage incurred by the malicious code can be minimized through preemptive detection and measurement.

Since unknown attacking techniques such as malicious use of vulnerability, application of detection avoidance techniques and the like are evolved recently, detection techniques need to be enhanced. Typical methods of inspecting a website hiding a malicious code includes a low interaction web crawling detection method which is speedy but signature-dependent and a high interaction behavior-based detection method having a wide detection range and capable of detecting an unknown attack with a low speed.

However, there are a large number of websites operating on the Internet, and the number of inspection target URLs will be millions, tens of millions or more considering sub-pages. In order to perform inspection on the large number of websites through a high interaction system, the analysis environment consuming two to three minutes to inspect one website should be improved greatly to practically use the inspection method.

### SUMMARY OF THE INVENTION

Therefore, the present invention has been made in view of the above problems, and it is an object of the present invention to provide a method of inspecting mass websites at a high speed, which visits and inspects the mass websites at a high speed using multiple browsers and multiple frames.

In addition, another object of the present invention is to provide a method of inspecting mass websites at a high speed, which promptly determines whether a vulnerability attack is generated or malicious code infection is attempted at a visiting target site.

In addition, another object of the present invention is to provide a method of inspecting mass websites at a high speed, which extracts a malicious URL in a malicious website confirmed to be malicious through visit inspection on the website and determination of maliciousness.

To accomplish the above objects, according to one aspect of the present invention, there is provided a method of inspecting mass websites at a high speed, the method including the steps of: simultaneously visiting, if a list of inspection target websites is received, a plurality of inspection target websites using multiple browsers; inspecting whether or not malicious code infection is attempted at the plurality of inspection target websites visited through the multiple browsers; extracting a malicious website where the attempt of malicious code infection is generated among the plurality of inspection target websites; and visiting the malicious website and tracing a malicious URL distributing a malicious code.

In addition, at the step of visiting a plurality of inspection target websites, only connectible inspection target websites are visited through a preliminary inspection of whether or not inspection target websites included in the list of mass inspection target websites are connectible.

In addition, the preliminary inspection is simultaneously inspecting whether or not a plurality of corresponding inspection target websites is connectible using a plurality of threads.

In addition, at the step of visiting a plurality of inspection target websites, the visit inspection is performed again using a tree search if the attempt of malicious code infection is confirmed among the plurality of inspection target websites.

In addition, at the step of inspecting whether or not malicious code infection is attempted, whether or not the malicious code infection is attempted is determined using behavior information generated at a time of visit inspection.

In addition, at the step of inspecting whether or not malicious code infection is attempted, whether or not the malicious code infection is attempted is correctly grasped through a correlation analysis among a file, a process and a registry phenomenon created when the plurality of inspection target websites is visited.

In addition, at the step of tracing a malicious URL, the malicious URL distributing the malicious code is confirmed through a query session differentiation analysis of a full-patch environment and a un-patch environment.

### BRIEF DESCRIPTION OF THE DRAWINGS

FIG. 1 is a flowchart illustrating a method of inspecting mass websites at a high speed according to the present invention.

FIG. 2 is a view showing an example of visiting a plurality of inspection target websites using multiple browsers according to the present invention.

FIG. 3 is a flowchart illustrating a procedure of promptly determining whether or not an attempt of malicious code infection is generated according to the present invention.

FIG. 4 is a flowchart illustrating a procedure of tracing a malicious URL according to the present invention.

### DETAILED DESCRIPTION OF THE PREFERRED EMBODIMENT

An embodiment according to the present invention will be hereafter described in detail with reference to the accompanying drawings.

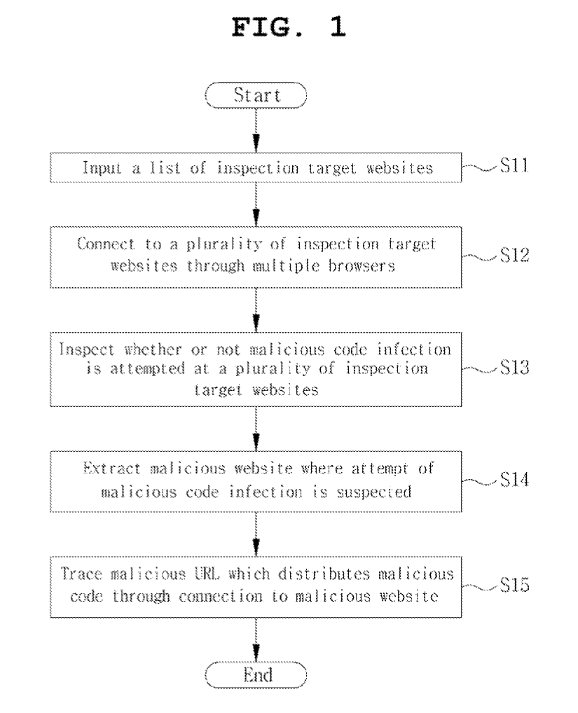

FIG. 1 is a flowchart illustrating a method of inspecting mass websites at a high speed according to the present invention.

Referring to FIG. 1, an inspection server for inspecting mass websites at a high speed according to the present invention receives a list of mass inspection target websites S11. At this point, the inspection server confirms whether or not the mass inspection target websites are connectible and performs visit inspection only on the websites confirmed to be connectible (alive). In order to confirm whether or not the inspection target websites are connectible at a high speed, the inspection server transmits a domain name system (DNS) inquiry and confirms whether or not a response is received. If a DNS response is received, the inspection server transmits a synchronization signal for the TCP 80 port, and if an affirmative response signal is received, the inspection server determines that a web service is provided through the TCP 80 port. Here, the inspection server may confirm in advance whether or not it is possible to simultaneously connect to a plurality of websites using multiple threads.

If the inspection server receives the inspection target website list, it simultaneously connects to a plurality of inspection target websites using multiple browsers S12. Here, the inspection target website list is configured of URLs of mass inspection target websites. Then, the inspection server executes the browsers by a predetermined unit of simultaneously connectible websites and visits the inspection target websites through the browsers. For example, if one hundred browsers can be simultaneously executed, the inspection server connects to the inspection target websites of the inspection target website list by the unit of one hundred.

The inspection server inspects whether or not malicious code infection is attempted in the plurality of inspection target websites S13. The inspection server may confirm whether or not an attack of infecting a website with a malicious code is generated through a correlation analysis among a file, a process and a registry phenomenon created after the inspection target websites are visited.

If an attempt of malicious code infection is detected among the plurality of inspection target websites, the inspection server extracts a malicious website S14. At this point, the inspection server extracts the malicious website among the plurality of inspection target websites while narrowing an inspection range at a predetermined rate using a tree search.

If a malicious website is extracted, the inspection server connects to the malicious website and traces a malicious URL distributing the malicious code S15. Here, the inspection server extracts connection URLs additionally connected when the malicious website is visited and traces a vulnerability attack URL by revisiting the malicious website while blocking the extracted connection URLs one by one.

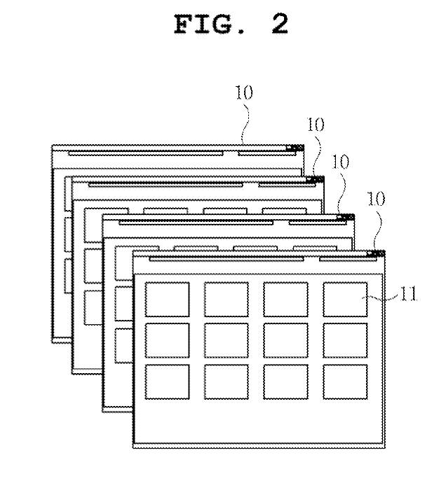

FIG. 2 is a view showing an example of visiting a plurality of inspection target websites using multiple browsers according to the present invention.

As shown in FIG. 2, the inspection server executes a plurality of browsers 10 and connects to inspection target websites through the browsers 10. At this point, if the inspection target website is a main page, the inspection server executes a predetermined number of multiple browsers 10 and simultaneously visits the inspection target websites. For example, the inspection server executes thirty multiple browsers 10 and simultaneously visits thirty different inspection target websites through the browsers.

Meanwhile, if the inspection target web page is a sub-page, the speed is amplified by simultaneously using a multi-frame visit technique. For example, if twenty browsers 10 respectively having five frames 11 are simultaneously open and the inspection target websites are visited, it is possible to inspect one hundred (5×20) websites with one inspection. In the present invention, the multi-frame is used only when a sub-page is inspected.

If an attempt of malicious code infection is not detected although a plurality of websites is simultaneously visited using the multiple browsers 10 and the multiple frames 11, the next inspection target group is visited, and if an attempt of infection is confirmed, a website having a problem (malicious website) is traced among the simultaneously visited websites. At this point, when the website having a problem is traced, the website is promptly found with a minimum number of inspections using a tree search.

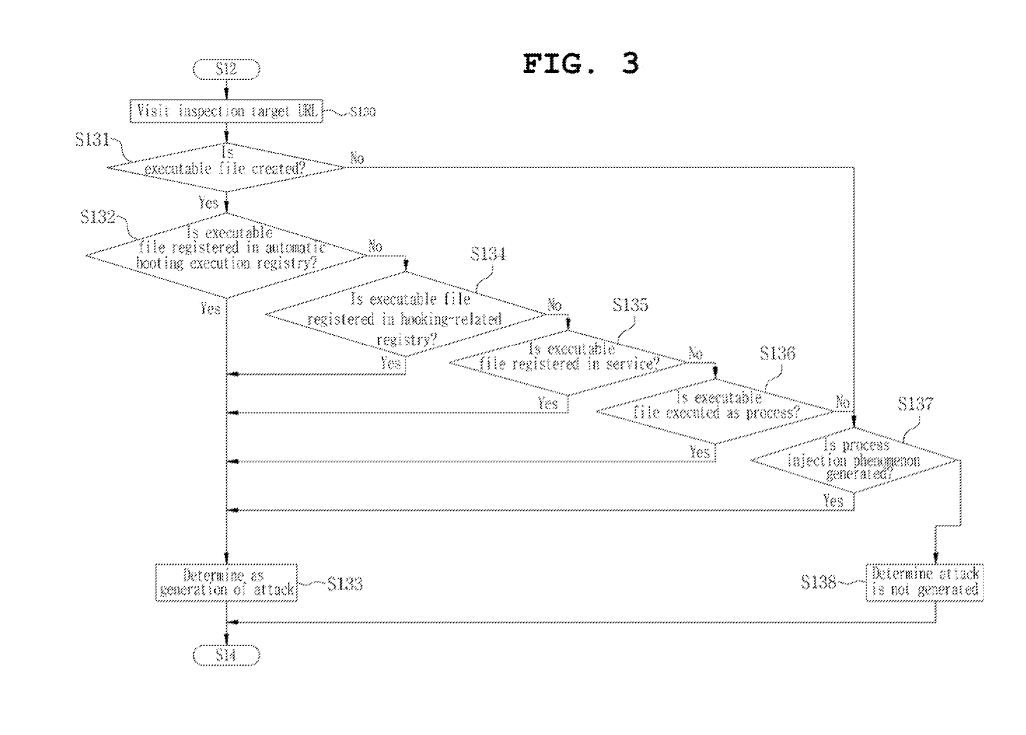

FIG. 3 is a flowchart illustrating a procedure of promptly determining whether or not an attempt of malicious code infection is generated according to the present invention.

First, the inspection server confirms whether or not an executable file is created when a plurality of inspection target URLs is connected using multiple browsers 5130 and 5131.

If the executable is created, the inspection server confirms whether or not the created executable file is registered in an automatic booting execution registry S132.

If the created executable file is registered in the automatic booting execution registry, the inspection server determines that an attempt of malicious code infection is generated S133.

If the created executable file is not registered in the automatic booting execution registry, the inspection server confirms whether or not the created executable file is registered in a hooking-related registry S134. If the created executable file is registered in the hooking-related registry, the inspection server determines that an attempt of malicious code infection is generated S133.

If the created executable file is not registered in the hooking-related registry, the inspection server confirms whether or not the created executable file is registered in a service S135.

If the created executable file is registered in a service, the inspection server determines that an attack attempting malicious code infection is generated S133, and if the created executable file is not registered in the service, the inspection server confirms whether or not the created executable file is executed as a process S136.

If the created executable file is executed as a process, the inspection server determines that an attack attempting malicious code infection is generated S133.

If the created executable file is not executed as a process, the inspection server confirms whether or not a process injection phenomenon is generated S137.

If the process injection phenomenon is generated, the inspection server determines that a malicious code infection attack is generated S133, and if the process injection phenomenon is not generated, the inspection server determines that a malicious code infection attack is not generated S138.

If the executable file is not created, the inspection server determines whether or not a malicious code infection attack is generated S138 by confirming whether or not the process injection phenomenon is generated S131 and S138.

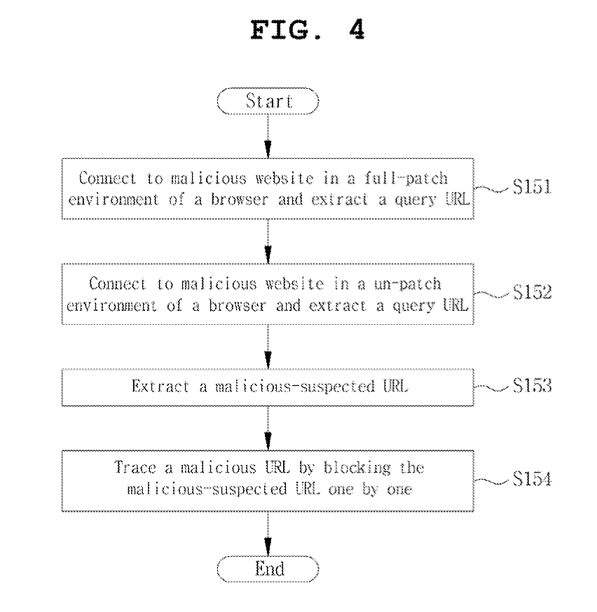

FIG. 4 is a flowchart illustrating a procedure of tracing a malicious URL according to the present invention.

A variety of codes exist in a malicious website, and it is extremely difficult to distinguish a normal code from an attacking code. However, a malicious URL distributing a malicious code, which is generated after an attack of a vulnerability attack code (exploit), may be confirmed through a query session differentiation analysis in a full-patch environment and a un-patch environment of a web browser.

First, the inspection server connects to a malicious website in the full-patch environment of a browser and extracts a query URL 5151.

Then, the inspection server connects to the malicious website in the un-patch environment of the browser and extracts a query URL 5152. In the un-patch environment, an additional query such as download of a malicious code is generated after a vulnerability attack is succeeded. In other words, the inspection server extracts a connection URL generating an additional connection after a malicious website is visited.

The inspection server extracts a malicious-suspected URL by excluding URLs confirmed to be identical in the full-patch environment from the URLs extracted in the un-patch environment S153. That is, sessions unconfirmed in the full-patch environment among the sessions generated in the un-patch environment are selected as malicious-suspected URLs.

The inspection server traces the malicious URL by blocking the URLs extracted as malicious-suspected URLs one by one, reconnecting to the malicious websites and confirming whether or not the malicious code infection phenomenon is generated S154. In other words, while the extracted malicious-suspected URLs are blocked one by one, the inspection server revisits the malicious websites and confirms whether or not a malicious code infection attack is generated. Then, if the malicious code infection attack is not generated, the inspection server determines a corresponding URL as a malicious code distribution website related to the attack.

Since the present invention performs visit inspection using multiple browsers and multiple frames, mass websites can be visited and inspected at a high speed.

Further, the present invention may promptly determine whether a vulnerability attack is generated or malicious code infection is attempted at a visiting target site.

Furthermore, the present invention may extract a malicious URL in a malicious website confirmed to be malicious through visit inspection on the website and determination of maliciousness.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of inspecting mass websites at a high speed, the method comprising the steps of:
simultaneously visiting, if a list of inspection target websites is received, a plurality of inspection target websites using multiple browsers;
inspecting whether or not malicious code infection is attempted at the plurality of inspection target websites visited through the multiple browsers;
extracting a malicious website where the attempt of malicious code infection is generated among the plurality of inspection target websites; and
visiting the malicious website and tracing a malicious URL distributing a malicious code.

2. The method according to claim 1, wherein at the step of visiting a plurality of inspection target websites, only connectible inspection target websites are visited through a preliminary inspection of whether or not inspection target websites included in the list of mass inspection target websites are connectible.

3. The method according to claim 2, wherein the preliminary inspection is simultaneously inspecting whether or not a plurality of corresponding inspection target websites is connectible using a plurality of threads.

4. The method according to claim 1, wherein at the step of visiting a plurality of inspection target websites, the visit inspection is performed again using a tree search if the attempt of malicious code infection is confirmed among the plurality of inspection target websites.

5. The method according to claim 1, wherein at the step of inspecting whether or not malicious code infection is attempted, whether or not the malicious code infection is attempted is determined using behavior information generated at a time of visit inspection.

6. The method according to claim 5, wherein at the step of inspecting whether or not malicious code infection is attempted, whether or not the malicious code infection is attempted is correctly grasped through a correlation analysis among a file, a process and a registry phenomenon created when the plurality of inspection target websites is visited.

7. The method according to claim 1, wherein at the step of tracing a malicious URL, the malicious URL distributing the malicious code is confirmed through a query session differentiation analysis of a full-patch environment and a un-patch environment.
